(19) United States
(12) Patent Application Publication
(10) Pub. No.: US 2023/0411743 A1
(43) Pub. Date: Dec. 21, 2023

(54) APPARATUS, SYSTEM, AND METHOD FOR ACHIEVING FLEXIBILITY AND DURABILITY IN BATTERIES

(71) Applicant: Meta Platforms Technologies, LLC, Menlo Park, CA (US)

(72) Inventors: Tianren Xu, Cupertino, CA (US); Karthik Kadirvel, Cupertino, CA (US); Hyung Gu Yun, Newcastle, WA (US); Jason Howard, Alpharetta, GA (US)

(21) Appl. No.: 17/899,286

(22) Filed: Aug. 30, 2022

Related U.S. Application Data
(60) Provisional application No. 63/353,379, filed on Jun. 17, 2022.
(60) Provisional application No. 63/356,102, filed on Jun. 28, 2022.

(51) Int. Cl. H01M 50/136; H01M 4/70; H01M 50/46

(52) U.S. Cl. CPC H01M 50/136; H01M 4/70; H01M 50/46; H01M 2004/021

(57) ABSTRACT

A flexible battery comprising (1) at least one positively charged layer, (2) at least one negatively charged layer, (3) a coated electrode segment that includes a segment of the positively charged layer and a segment of the negatively charged layer, and (4) an additional coated electrode segment movably coupled to the coated electrode segment, wherein the additional coated electrode segment includes an additional segment of the positively charged layer and an additional segment of the negatively charged layer. Various other apparatuses, devices, systems, and methods are also disclosed.

### CROSS-REFERENCE TO RELATED APPLICATIONS

This application claims the benefit of priority to U.S. Provisional Application Nos. 63/353,379 and 63/356,102, which were filed 17 Jun. 2022 and 28 Jun. 2022, respectively. The contents of these provisional applications are also incorporated herein by reference in their entirety.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is an illustration of an exemplary flexible battery according to one or more embodiments of this disclosure.

FIG. 2 is an illustration of an exemplary flexible battery according to one or more embodiments of this disclosure.

FIG. 3 is an illustration of an exemplary flexible battery according to one or more embodiments of this disclosure.

FIG. 4 is an illustration of an exemplary flexible battery according to one or more embodiments of this disclosure.

FIG. 5 is an illustration of an exemplary flexible battery according to one or more embodiments of this disclosure.

FIG. 6 is an illustration of an exemplary flexible battery according to one or more embodiments of this disclosure.

FIG. 7 is a flowchart of an exemplary method for achieving flexibility and durability in batteries according to one or more embodiments of this disclosure.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

FIG. 10 is an illustration of exemplary haptic devices that may be used in connection with embodiments of this disclosure.

FIG. 11 is an illustration of an exemplary virtual-reality environment according to embodiments of this disclosure.

FIG. 12 is an illustration of an exemplary augmented-reality environment according to embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for achieving flexibility and durability in batteries. As will be explained in greater detail below, these apparatuses, systems, and methods may provide numerous features and benefits.

Wearable devices often include and/or incorporate batteries that serve as power sources for powering onboard electronics and/or components. Wearable designers may face and/or encounter certain design constraints that influence various features and/or characteristics (e.g., the size, shape, and/or weight) of wearable devices. For example, to extend and/or increase the battery life of wearable devices, wearable designers may select and/or implement batteries that consume and/or occupy a significant amount of space within and/or on the wearable devices. However, to increase and/or improve comfort and/or usability, wearable designers may try to minimize and/or limit the size of the wearable devices. Unfortunately, one of the features that often adds significantly to the size and/or bulk of wearable devices may be batteries.

Accordingly, wearable designers may search for and/or develop different ways of integrating and/or hiding the batteries in the wearable devices. For example, if they were flexible and/or bendable, batteries may be able to fit inside wristbands or necklaces of wearable devices. In some examples, such batteries may include and/or represent various positively charged layers and negatively charged layers wound and/or stacked together and decoupled by separators. In one example, a battery may achieve flexibility and/or bendability by implementing an array of coated electrode segments that include various positively charged layers and negatively charged layers. In this example, the coated electrode segments of the battery may be separated by air, gas, and/or a filler material.

In some examples, the various positively charged layers and negatively charged layers of the battery may be chemically bonded together in a stack and/or wrapped in a pouch package to provide structure and/or support. In one example, the chemical bonding and/or the pouch package may stabilize and/or hold each coated electrode segment in place relative to its neighboring coated electrode segments. In this example, a current collector may be disposed and/or applied across each positively charged and/or negatively charged layer. The coated electrode segments may remain rigid while the gaps between such coated electrode segments facilitate, support, and/or provide flexibility to the battery as a whole. The overall flexibility of the battery may be defined and/or controlled by the sizes of the individual coated segments and/or the adjacent gaps between the coated segments.

In some examples, a flexible battery may include and/or represent various positively charged layers (e.g., positive electrodes and/or cathodes) that obtain and/or acquire electrons from and/or through a circuit. In such examples, the positively charged layers may be reduced during electrochemical reactions that produce electricity and/or power in connection with the battery. In other words, the positively charged layers may be electrochemically reduced as the battery discharges.

Additionally or alternatively, the flexible battery may include and/or represent various negatively charged layers (e.g., negative electrodes and/or anodes) that release electrons to and/or through the circuit. In such examples, the negatively charged layers may oxidize during the electrochemical reactions that produce electricity and/or power in connection with the battery. In other words, the negatively charged layers may be electrochemically oxidized as the battery discharges. The positively charged and/or negatively charged layers may collectively constitute and/or represent the internal core of the battery.

In some examples, the positively charged and negatively charged layers may include and/or incorporate current collectors that electrically couple different coated segments together. In one example, the current collector disposed on and/or applied to the cathode materials may include and/or represent aluminum foil and/or sheeting. Additionally or alternatively, the current collector disposed on and/or applied to the anode materials may include and/or represent copper foil and/or sheeting. In one example, each positively charged and/or negatively charged layer may include and/or incorporate at least one current collector.

In some examples, each positively charged layer may include and/or represent a series or string of individual segments that contain cathode material and/or are separated by gaps. Examples of cathode materials include, without limitation, cobalt, nickel, manganese, lithium, iron, oxygen, variations or combinations of one or more of the same, and/or any other suitable cathode materials.

In some examples, each negatively charged layer may include and/or represent a series or string of individual segments that contain anode material and/or are separated by gaps. Examples of anode materials include, without limitation, graphite, iron, carbon, steel, lithium, silicon, oxygen, variations or combinations of one or more of the same, and/or any other suitable anode materials.

In some examples, individual electrode segments included in the positively charged and/or negatively charged layers may be stacked and/or compiled together. In such examples, the positively charged and/or negatively charged segments included in each stack and/or compilation may alternate relative to one another. In one example, each stack and/or compilation may be covered, surrounded, and/or encased by a coating (e.g., a pouch package) to a form and/or produce a coated electrode segment. In this example, the coated electrode segments may be rigid and/or stiff as individual features and/or components. However, when the individual coated electrode segments are coupled and/or connected together as a battery, the individual coated segments may remain rigid and/or stiff, but the battery as a whole may achieve a certain amount of flexibility through the gaps between the coated electrode segments. The amount of flexibility achieved by the battery may be defined, varied, and/or controlled by the size of the coated electrode segments and/or the gaps between the coated electrode segments.

In some examples, the positively charged and negatively charged layers of the battery may be alternately stacked atop one another within the internal core. In one example, the positively charged and negatively charged layers of the battery may be separated, isolated, and/or insulated from one another by one or more separators that each serve and/or function as an intermediary layer that is ionically conductive but electrically insulating. For example, a polymer separator may be disposed and/or applied between each of the positively charged and negatively charged layers. In this example, the positively charged and negatively charged layers may be aligned in the stack such that columns of coated electrode segments are formed across the layers and/or columns of gaps are formed between the coated electrode segments within the internal core of the battery.

In some examples, each positively charged and negatively charged layer of the battery may include and/or represent a similar or identical number of segments as one another.

In one example, the stacking of the positively charged and negatively charged layers may result in and/or lead to the first segment of each positively charged layer aligning with the first segment of each negatively charged layer. In this example, the stacking of the positively charged and negatively charged layers may also result in and/or lead to the second segment of each positively charged layer aligning with the second segment of each negatively charged layer. Additionally or alternatively, the stacking of the positively charged and negatively charged layers may result in and/or lead to gaps forming between the columns of coated segments in the positively charged and negatively charged layers. The gaps formed between the coated segments may give, provide, and/or facilitate flexibility for the battery as a whole.

In some examples, the positively charged and negatively charged layers may be wrapped, encased, and/or enshrouded in a pouch package. In one example, the pouch package may include and/or represent laminate material that holds the internal core of positively charged and negatively charged layers intact and/or together as individual coated electrode segments. Additionally or alternatively, the pouch package may be flexible, stretchable, bendable, and/or resilient.

In some examples, double-sided adhesives (e.g., double-sided tapes) may be added between the internal core of positively charged and negatively charged layers and the pouch package to prevent wrinkles from forming upon bending and/or flexing the battery. In one example, stiffeners (e.g., FR-4 and/or nickel) may be disposed on and/or applied to the exterior of the pouch package to flatten and/or provide support for the coated segments of the positively charged and/or negatively charged layers. In this example, the stiffeners may mitigate and/or prevent wrinkles from forming upon bending and/or flexing the battery.

In some examples, to induce and/or promote electrochemical reactions in the battery, the internal core may need to maintain good and/or electrically strong contacts across the different positively charged and negatively charged layers. In one example, the pouch package may support and/or provide pressure to the internal core at nearly vacuum levels. In this example, the difference between the pressure outside the pouch package and the pressure inside the pouch package may cause the pouch package to compress and/or firmly hold the internal core of the positively charged and/or negatively charged layers together. This compression and/or firm hold on the internal core may promote and/or support good electrical contact across the different positively charged and negatively charged layers of the battery.

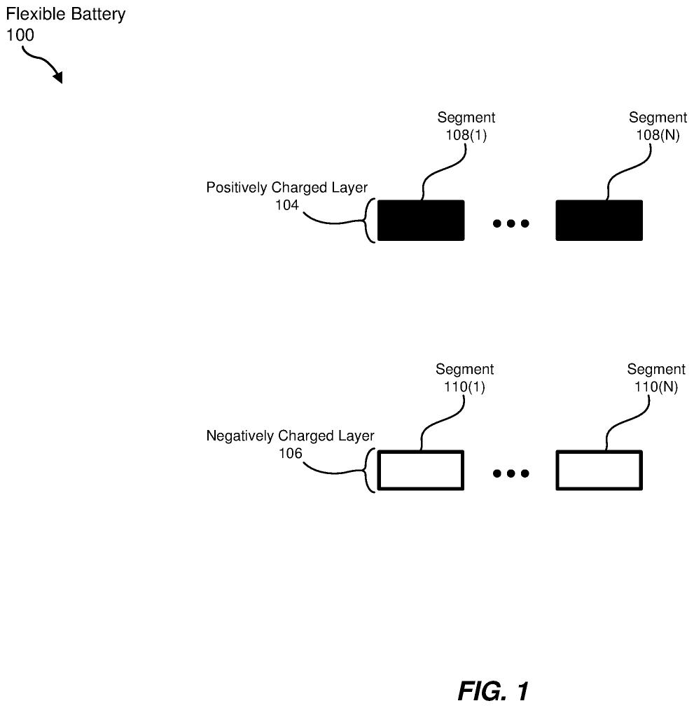

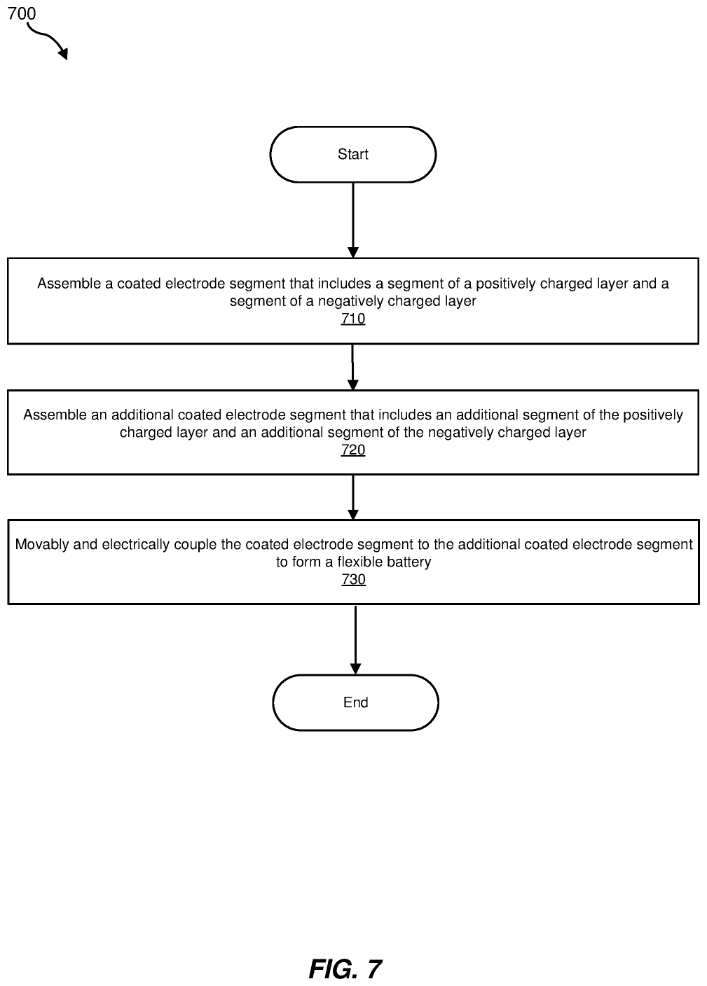

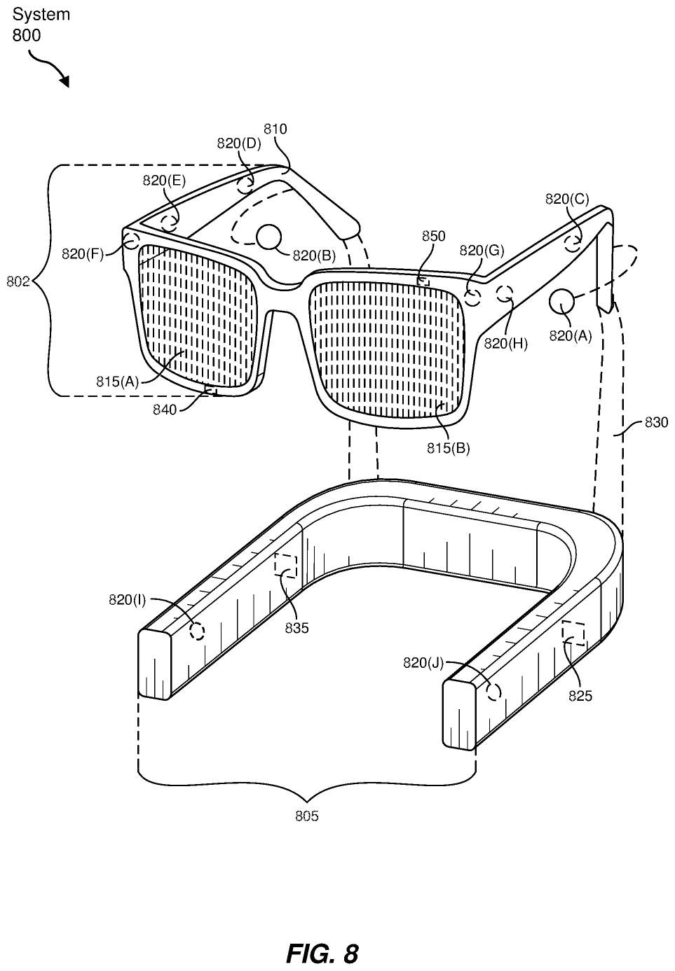

The following will provide, with reference to FIGS. 1-6, detailed descriptions of exemplary devices, systems, components, and corresponding implementations for achieving flexibility and durability in batteries. In addition, detailed descriptions of methods for achieving flexibility and durability in batteries will be provided in connection with FIG. 7. The discussion corresponding to FIGS. 8-12 will provide detailed descriptions of types of exemplary artificial-reality devices, wearables, and/or associated systems capable of achieving flexibility and durability in batteries.

FIG. 1 illustrates a portion of an exemplary flexible battery 100 that includes and/or represents at least one positively charged layer 104 and at least one negatively charged layer 106. In some examples, positively charged layer 104 may include and/or represent segments 108(1)-(N), and/or negatively charged layer 106 may include and/or represent segments 110(1)-(N). In such examples, segments 108(1)-(N) of positively charged layer 104 may include and/or represent pieces of positively charged material, and/or segments 110(1)-(N) of negatively charged layer 106 may include and/or represent pieces of negatively charged material.

In some examples, positively charged layer 104 may include and/or represent a cathode and/or a positive electrode. Additionally or alternatively, negatively charged layer 106 may include and/or represent an anode and/or a negative electrode.

In some examples, flexible battery 100 may include and/or represent any type or form of portable electric power source. In one example, flexible battery 100 may include and/or represent electrochemical cells capable of sourcing and/or providing electric power or current to one or more circuits and/or devices. Examples of flexible battery 100 include, without limitation, lithium-ion batteries, lithium-polymer batteries, primary lithium batteries, alkaline batteries, aluminum-ion batteries, rechargeable batteries, primary cell batteries, secondary cell batteries, flow batteries, metal-air batteries, nickel-cadmium batteries, nickel-metal hydride batteries, combinations or variations of one or more of the same, and/or any other suitable type of battery.

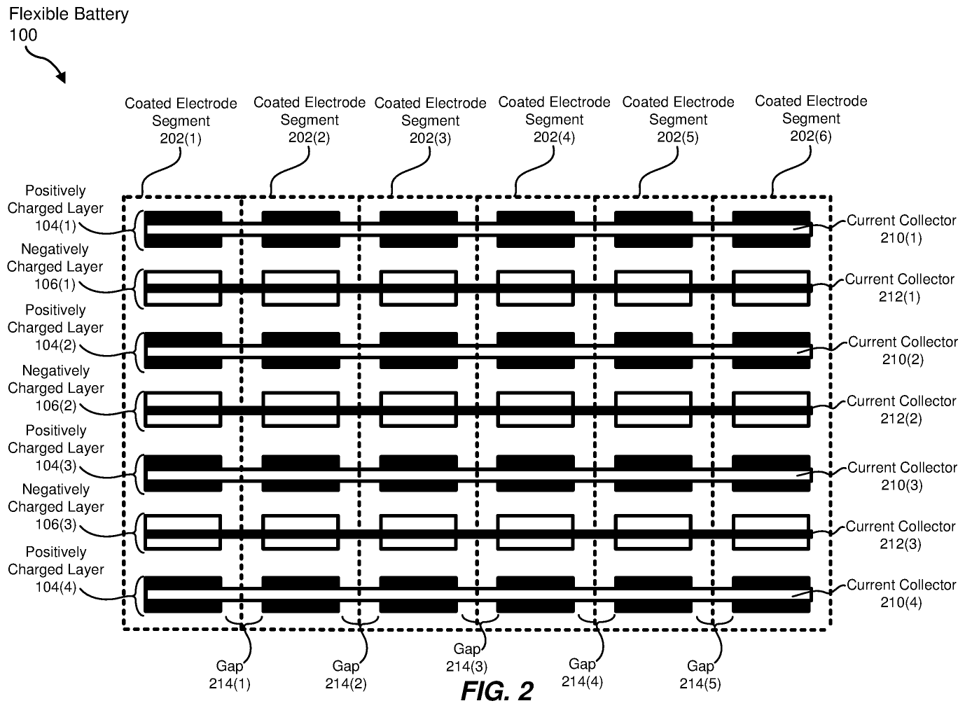

FIG. 2 illustrates an exemplary implementation of flexible battery 100. As illustrated in FIG. 2, exemplary flexible battery 100 may include and/or represent stacks, pillars, or columns of alternating positively charged and negatively charged segments. In some examples, flexible battery 100 may include and/or represents positively charged layers 104(1), 104(2), 104(3), and 104(4) as well as negatively charged layers 106(1), 106(2), and 106(3). In such examples, each of positively charged layers 104(1)-(4) may include and/or represent multiple segments and/or pieces of cathode material separated by gaps and/or space. Additionally or alternatively, each of negatively charged layers 106(1)-(3) may include and/or represent multiple segments and/or pieces of anode material separated by gaps and/or space.

In some examples, each stack, pillar, and/or column of alternating cathode and anode segments may constitute, represent, and/or form a coated electrode segment. In one example, flexible battery 100 may include and/or represent coated electrode segments 202(1), 202(2), 202(3), 202(4), 202(5), and 202(6). In this example, each of coated electrode segments 202(1)-(6) may include and/or represent a segment and/or piece from all positively charged layers 104(1)-(4) and negatively charged layers 106(1)-(3). The cathode and/or anode segments included in each of coated electrode segments 202(1)-(6) may alternate relative to one another. For example, coated electrode segment 202(1) may include and/or represent a stack arranged in the following order: a segment of positively charged layer 104(1), a segment of negatively charged layer 106(1), a segment of positively charged layer 104(2), a segment of negatively charged layer 106(2), a segment of positively charged layer 104(3), a segment of negatively charged layer 106(3), and/or a segment of positively charged layer 104(4).

In some examples, coated electrode segments 202(1)-(6) may be separated and/or spaced from one another by gaps. For example, coated electrode segments 202(1) and 202(2) may be separated and/or spaced from one another by a gap 214(1), and coated electrode segments 202(2) and 202(3) may be separated and/or spaced from one another by a gap 214(2). In this example, coated electrode segments 202(3) and 202(4) may be separated and/or spaced from one another by a gap 214(3), and coated electrode segments 202(4) and 202(5) may be separated and/or spaced from one another by a gap 214(4). Additionally or alternatively, coated electrode segments 202(5) and 202(6) may be separated and/or spaced from one another by a gap 214(5). Examples of gaps 214(1)-(5) include, without limitation, pockets of air, pockets of gas, filler material, space, combinations or variations of one or more of the same, and/or any other suitable gaps.

In some examples, coated electrode segments 202(1)-(6) may be electrically coupled and/or connected to one another by current collectors applied across positively charged layers 104(1)-(4) and negatively charged layers 106(1)-(3). For example, positively charged layers 104(1)-(4) may include and/or represent current collectors 210(1), 210(2), 210(3), and 210(4), respectively. In this example, current collectors 210(1)-(4) may be applied and/or electrically coupled across various cathode segments and/or pieces included in positively charged layers 104(1)-(4), respectively. In one example, current collectors 210(1)-(4) may include and/or represent aluminum foil and/or sheeting.

In some examples, negatively charged layers 106(1)-(3) may include and/or represent current collectors 212(1), 212(2), and 212(3), respectively. In such examples, current collectors 212(1)-(3) may be applied and/or electrically coupled across various anode segments and/or pieces included in negatively charged layers 106(1)-(3), respectively. In one example, current collectors 212(1)-(3) may include and/or represent copper foil and/or sheeting.

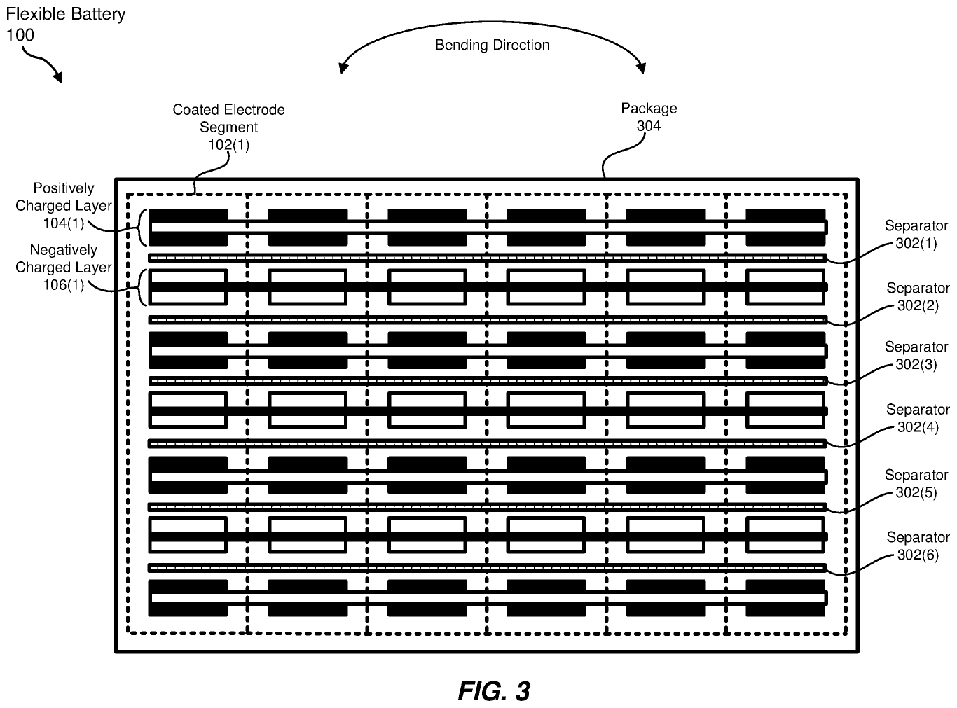

FIG. 3 illustrates another exemplary implementation of flexible battery 100. As illustrated in FIG. 3, exemplary flexible battery 100 may also include and/or represent a package 304 that encases and/or enshrouds positively charged layers 104(1)-(4) and negatively charged layers 106(1)-(3). In some examples, package 304 may effectively cover and/or coat electrode segments 102(1)-(6) of flexible battery 100. In such examples, package 304 may provide structure and/or support to coated electrode segments 102(1)-(6). Additionally or alternatively, package 304 may compress coated electrode segments 102(1)-(6) to ensure and/or maintain good and/or electrically strong contacts across positively charged layers 104(1)-(4) and negatively charged layers 106(1)-(3).

In one example, package 304 may support and/or provide pressure to the internal core of flexible battery 100 at near-vacuum levels. In this example, the difference between the pressure outside package 304 and the pressure inside package 304 may cause and/or force package 304 to compress and/or firmly hold the internal core of positively charged layers 104(1)-(4) and negatively charged layers 106(1)-(3) together. This compression and/or firm hold on the internal core may promote and/or support good electrical contact across positively charged layers 104(1)-(4) and negatively charged layers 106(1)-(3).

In some examples, exemplary flexible battery 100 may further include and/or represent separators applied and/or positioned between positively charged layers 104(1)-(4) and negatively charged layers 106(1)-(3). For example, a separator 302(1) may be applied and/or positioned between positively charged layer 104(1) and negatively charged layer 106(1), and a separator 302(2) may be applied and/or positioned between negatively charged layer 106(1) and positively charged layer 104(2). In this example, a separator 302(3) may be applied and/or positioned between positively charged layer 104(2) and negatively charged layer 106(2), and a separator 302(4) may be applied and/or positioned between negatively charged layer 106(2) and positively charged layer 104(3). Additionally or alternatively, a separator 302(5) may be applied and/or positioned between positively charged layer 104(3) and negatively charged layer 106(3), and a separator 302(6) may be applied and/or positioned between negatively charged layer 106(3) and positively charged layer 104(4).

In some examples, separators 302(1)-(6) may each electrically insulate the corresponding positively charged and negatively charged layers from one another. In such examples, separators 302(1)-(6) may each include and/or represent an insulation material and/or substance that is a poor conductor of electricity and/or is polarized by an electric field. In one example, separators 302(1)-(6) may each be implemented as solids, liquids, and/or gases. For example, separators 302(1)-(6) may include and/or represent polymer separators. Examples of separators 302(1)-(6) include, without limitation, polyethylene or polypropylene films, polymer, gels, ceramics, porcelains, glasses, plastics, industrial coatings, silicon, germanium, gallium arsenide, mica, metal oxides, silicon dioxides, sapphires, aluminum oxides, dielectrics, variations or combinations of one or more of the same, and/or any other suitable separator materials.

In some examples, the gaps separating coated electrode segments 102(1)-(6) may enable positively charged layers 104(1)-(4) and negatively charged layers 106(1)-(3) to bend and/or flex across coated electrode segments 102(1)-(6) and/or flexible battery 100 as a whole. In one example, such gaps may enable flexible battery 100 to bend and/or flex rotationally and/or radially. For example, if flexible battery 100 were inserted and/or implemented in a wristband of a wearable device, flexible battery 100 may be able to bend and/or flex around the wrist of a user of the wearable device due at least in part to the gaps separating coated electrode segments 102(1)-(6).

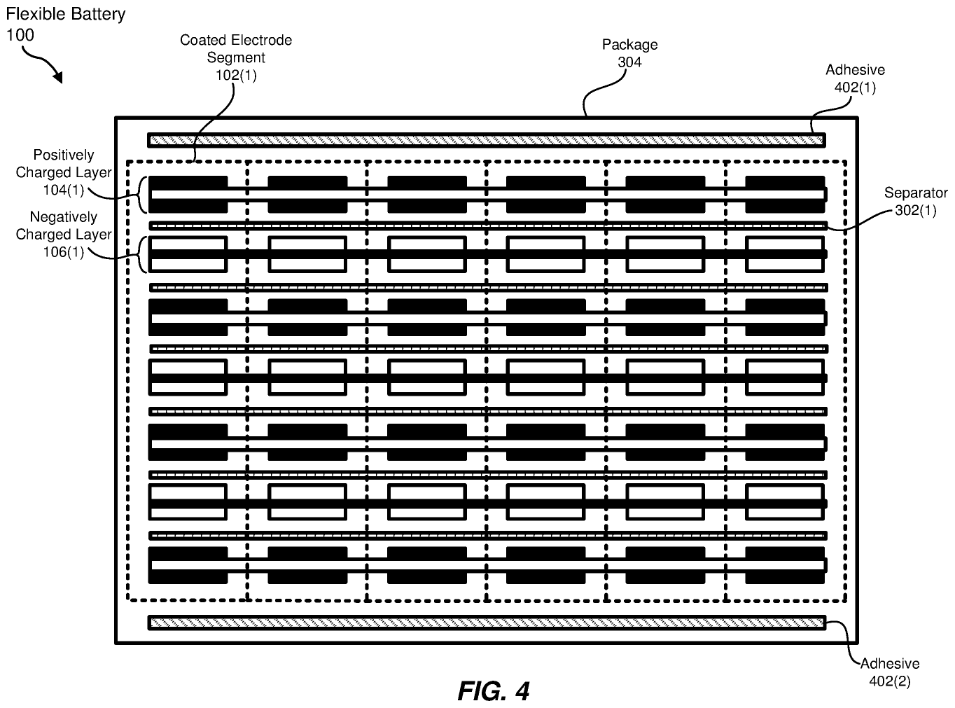

FIG. 4 illustrates an additional exemplary implementation of flexible battery 100. As illustrated in FIG. 4, exemplary flexible battery 100 may also include and/or represent one or more adhesives that provide additional structural integrity to the internal core. For example, an adhesive 402(1) may be applied, incorporated, and/or coupled between an interior portion of package 304 and positively charged layer 104(1). Additionally or alternatively, an adhesive 402(2) may be applied, incorporated, and/or coupled between another interior portion of package 304 and positively charged layer 104(4). In one example, adhesives 402(1) and 402(2) may keep and/or prevent coated electrode segments 202(1)-(6) from becoming misaligned, askew, and/or crooked.

In one example, adhesives 402(1) and 402(2) may include and/or represent double-sided tape that adheres and/or secures positively charged layers 104(1) and 104(4) to the internal portions of package 304. In another example, adhesives 402(1) and 402(2) may include and/or represent a glue and/or silicone that adheres and/or secures positively charged layers 104(1) and 104(4) to the internal portions of package 304.

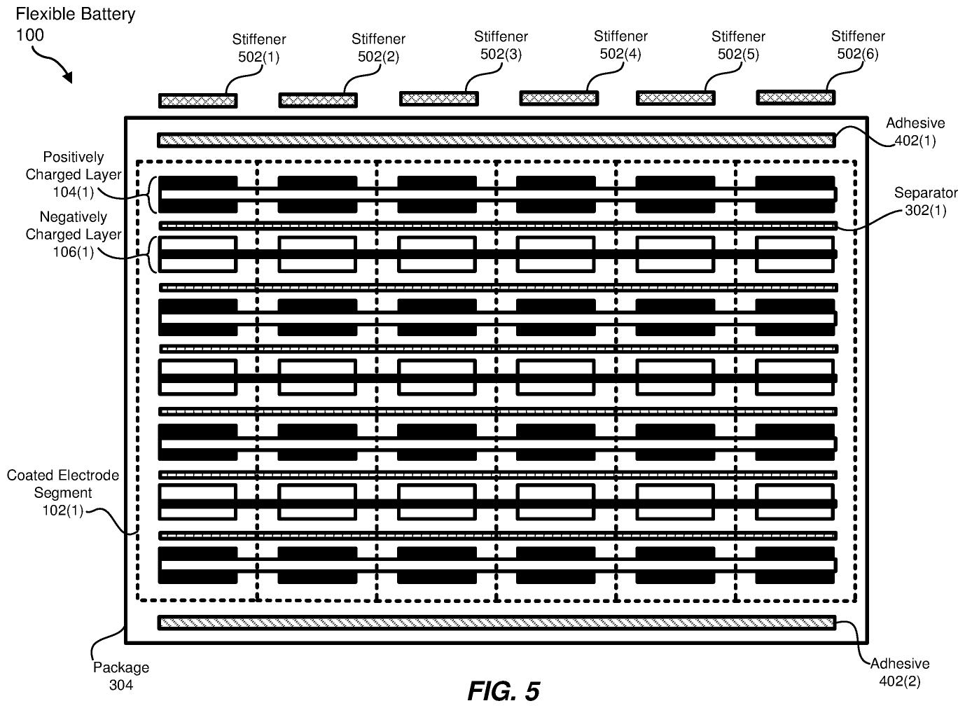

FIG. 5 illustrates a further exemplary implementation of flexible battery 100. As illustrated in FIG. 5, exemplary flexible battery 100 may also include and/or represent one or more stiffeners that provide further structural integrity to the internal core. For example, a stiffener 502(1) may be applied, fixed, and/or coupled to an external portion of package 304 atop and/or aligned with coated electrode segment 202(1), and a stiffener 502(2) may be applied, fixed, and/or coupled to an external portion of package 304 atop and/or aligned with coated electrode segment 202(2). In this example, a stiffener 502(3) may be applied, fixed, and/or coupled to an external portion of package 304 atop and/or aligned with coated electrode segment 202(3), and a stiffener 502(4) may be applied, fixed, and/or coupled to an external portion of package 304 atop and/or aligned with coated electrode segment 202(4). Additionally or alternatively, a stiffener 502(5) may be applied, fixed, and/or coupled to an external portion of package 304 atop and/or aligned with coated electrode segment 202(5), and a stiffener 502(6) may be applied, fixed, and/or coupled to an external portion of package 304 atop and/or aligned with coated electrode segment 202(6).

In some examples, stiffeners 502(1)-(6) may include and/or represent any type or form of physical material, structure, brace, and/or support feature that fastens, couples, and/or adheres to package 304. In one example, stiffeners 502(1)-(6) may be aligned with the various cathode and anode segments included in coated electrode segments 202(1)-(6), respectively. In this example, gaps and/or spaces may separate stiffeners 502(1)-(6) from one another to facilitate bending and/or flexing across coated electrode segments 102(1)-(6) and/or flexible battery 100 as a whole.

In addition, stiffeners 502(1)-(6) may be of any suitable dimensions. In some examples, stiffeners 502(1)-(6) may be dimensioned to provide a certain amount of rigidity to coated electrode segments 202(1)-(6) to mitigate and/or avoid damage to the internal core of flexible battery 100. Stiffeners 502(1)-(6) may include and/or contain any of a variety of materials. In one example, stiffeners 502(1)-(6) may include and/or contain FR-4 laminate material and/or nickel. Additional examples of such materials include, without limitation, plastics, ceramics, polymers, metals, composites, laminates, glasses, combinations or variations of one or more of the same, and/or any other suitable materials.

In some examples, stiffeners 502(1)-(6) may serve as a foundation and/or base that provides structural support, tension, strength, and/or integrity to coated electrode segments 202(1)-(6). In one example, stiffeners 502(1)-(6) may be placed, positioned, secured, and/or coupled to the outside of package 304. After placement, stiffeners 502(1)-(6) may provide structural support and/or strength to coated electrode segments 202(1)-(6). By providing such structural support to coated electrode segments 202(1)-(6) in this way, stiffeners 502(1)-(6) may improve the durability of flexible battery 100 and/or prevent the internal core of flexible battery 100 from experiencing damage.

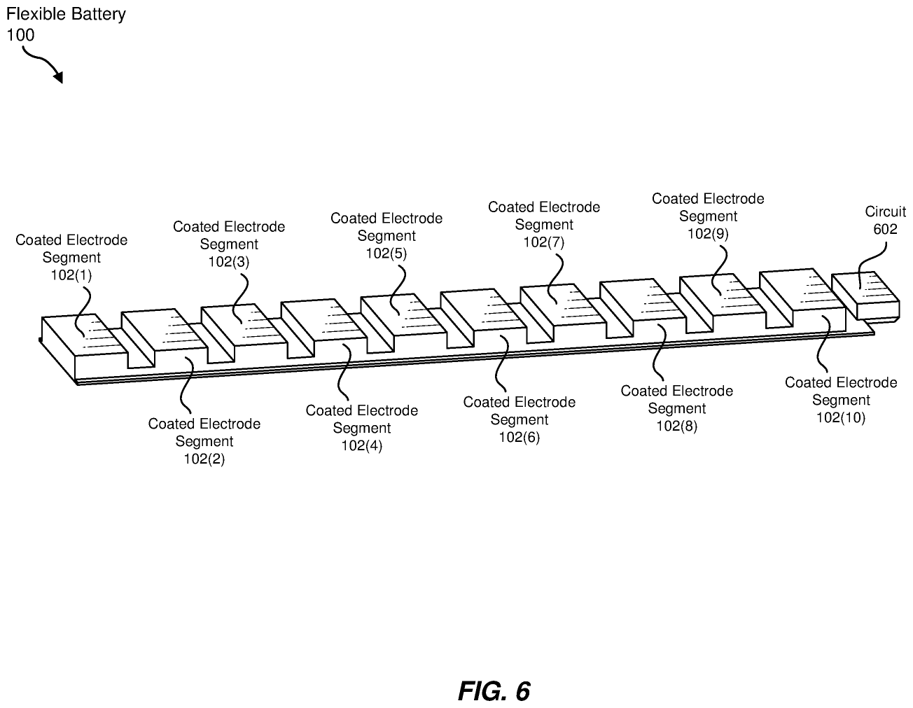

FIG. 6 illustrates an additional exemplary implementation of flexible battery 100. As illustrated in FIG. 6, exemplary flexible battery 100 may include and/or represent a series and/or array of coated electrode segment that contain alternating positively charged and negatively charged layers. In one example, flexible battery 100 may include and/or represent coated electrode segments 102(1), 102(2), 102(3), 102(4), 102(5), 102(6), 102(7), 102(8), 102(9), and 102(10) that are electrically linked, coupled, and/or connected in a linear and/or daisy-chain fashion. In this example, coated electrode segment 102(10) may be electrically and/or physically coupled to a circuit 602. Accordingly, flexible battery 100 may source and/or provide electric power to circuit 602.

In some examples, flexible battery 100 may be integrated into and/or hidden in a wearable device. For example, flexible battery 100 may be able to fit inside a wristband or necklace of a wearable device. In one example, a wearable may include and/or represent any type or form of computing device that is worn as part of an article of clothing, an accessory, and/or an implant. Examples of such a wearable include, without limitation, wristbands, armbands, pendants, bracelets, rings, jewelry, ankle bands, clothing, smartwatches, electronic textiles, shoes, clips, headbands, gloves, variations or combinations of one or more of the same, and/or any other suitable wearable devices.

FIG. 7 is a flow diagram of an exemplary method 700 for achieving flexibility and durability in batteries. In one example, the steps shown in FIG. 7 may be performed during the manufacture and/or assembly of a battery and/or a wearable device. Additionally or alternatively, the steps shown in FIG. 7 may incorporate and/or involve various sub-steps and/or variations consistent with one or more of the descriptions provided above in connection with FIGS. 1-6.

As illustrated in FIG. 7, method 700 may include and/or involve the step of assembling a coated electrode segment that includes a segment of a positively charged layer and a segment of a negatively charged layer (710). Step 710 may be performed in a variety of ways, including any of those described above in connection with FIGS. 1-6. For example, a battery manufacturer and/or contractor may assemble, laminate, and/or construct a coated electrode segment that includes various alternating layers of cathode and/or anode segments.

In some examples, method 700 may also include and/or involve the step of assembling an additional coated electrode segment that includes an additional segment of the positively charged layer and an additional segment of the negatively charged layer (720). Step 720 may be performed in a variety of ways, including any of those described above in connection with FIGS. 1-6. For example, the battery manufacturer and/or contractor may assemble, laminate, and/or construct an additional coated electrode segment that includes additional segments from the various alternating positively charged and negatively charged layers.

In some examples, method 700 may also include and/or involve the step of movably and electrically coupling the coated electrode segment to the additional coated electrode segment to form a flexible battery (730). Step 730 may be performed in a variety of ways, including any of those described above in connection with FIGS. 1-6. For example, the battery manufacturer and/or contractor may movably and electrically couple the various coated electrode segments to one another to form a flexible battery.

As wearables are likely to undergo significant movement, bending, and/or jostling throughout their lifetime, protective measures and/or features may be able to reinforce the internal core of a flexible battery and/or potentially extend the life of the flexible battery. In some examples, an exoskeleton may enshroud, surround, and/or cover all or certain portions of the battery to reinforce the internal core and/or to protect the internal core against coming undone and/or disconnecting one or more positively charged and/or negatively charged layers. By doing so, the exoskeleton may increase the durability and/or resiliency of the battery and/or extend its life.

In some examples, an exoskeleton applied to a flexible battery of a wearable may include and/or represent individual armor capsules that are fitted to cover individual electrode segments of the flexible battery. In such examples, the individual armor capsules may be applied and/or fitted to the individual coated electrode segments. For example, each armor capsule may include and/or represent a top part or cover and a bottom part or cover. In this example, the top part or cover of each armor capsule may be attached and/or coupled to a top portion of a certain coated electrode segment of the battery, and the bottom part or cover of each armor capsule may be attached and/or coupled to a bottom portion of the certain coated electrode segment of the battery. Accordingly, the top and bottom parts or covers of each armor capsule may effectively sandwich a coated electrode segment of the battery. By doing so, the top and bottom parts or covers of each armor capsule may serve and/or function to compress and/or protect a coated electrode segment of the battery, thereby forcing the positively charged and negatively charged layers within the coated electrode segment together.

In some examples, the armor capsules may be contoured and/or shaped to fit and/or cover the coated electrode segments of the battery. In one example, the armor capsules may be individually applied and/or installed onto the coated electrode segments of the battery by way of an interference fit, a tension fit, a compression fit, a press fit, and/or a slip fit. Additionally or alternatively, the armor capsules may be individually attached and/or coupled to the coated electrode segments of the battery by way of an adhesive.

In other examples, rather than being comprised of individual armor capsules, the exoskeleton applied to the flexible battery of the wearable may include and/or represent a single protective or mechanical unit that at least partially encapsulates and/or encases the coated electrode segments of the battery. Additionally or alternatively, the exoskeleton applied to the flexible battery of the wearable may include and/or represent one or more top covers and one or more bottom covers that, when installed, at least partially encapsulate and/or encase the coated electrode segments of the battery.

In some examples, the wearable may include a wristband or a necklace that is shaped to house and/or hold the exoskeleton (e.g., the armor capsules) and the flexible battery. In one example, the wristband of a smartwatch may include and/or form a malleable and/or stretchable cavity, void, space, and/or vacancy shaped to fit around and/or hold the exoskeleton (e.g., the armor capsules) and the flexible battery together and/or intact. In this example, the wristband may be shaped and/or contoured to apply pressure and/or compress to the exoskeleton and/or the coated electrode segments of the battery.

### EXAMPLE EMBODIMENTS

Example 1: A flexible battery comprising (1) at least one positively charged layer, (2) at least one negatively charged layer, (3) a coated electrode segment that includes a segment of the positively charged layer and a segment of the negatively charged layer, and (4) an additional coated electrode segment movably coupled to the coated electrode segment, wherein the additional coated electrode segment includes an additional segment of the positively charged layer and an additional segment of the negatively charged layer.

Example 2: The flexible battery of Example 1, wherein the coated electrode segment and the additional coated electrode segment are electrically coupled to one another by (1) a current collector applied across the segment of the positively charged layer and the additional segment of the positively charged layer and (2) an additional current collector applied across the segment of the negatively charged layer and the additional segment of the negatively charged layer.

Example 3: The flexible battery of Example 1 or 2, further comprising a separator that is positioned between the positively charged layer and the negatively charged layer and electrically insulates the positively charged layer and the negatively charged layer from one another.

Example 4: The flexible battery of any of Examples 1-3, further comprising a package that encases the positively charged layer and the negatively charged layer and provides structural support to the coated electrode segment or the additional coated electrode segment.

Example 5: The flexible battery of any of Examples 1-4, further comprising an adhesive applied between an interior portion of the package and the positively charged layer or the negatively charged layer.

Example 6: The flexible battery of any of Examples 1-5, further comprising a stiffener applied to an exterior portion of the package atop the coated electrode segment or the additional coated electrode segment.

Example 7: The flexible battery of any of Examples 1-6, further comprising another coated electrode segment movably coupled to the additional coated electrode segment, wherein the another coated electrode segment includes another segment of the positively charged layer and another segment of the negatively charged layer.

Example 8: The flexible battery of any of Examples 1-7, wherein (1) the positively charged layer further comprises a plurality of gaps that separate the segment of the positively charged layer, the additional segment of the positively charged layer, and the another segment of the positively charged layer, and (2) the negatively charged layer further comprises a plurality of additional gaps that separate the segment of the negatively charged layer, the additional segment of the negatively charged layer, and the another segment of the negatively charged layer.

Example 9: The flexible battery of any of Examples 1-8, wherein the gaps and the additional gaps comprise at least one of (1) pockets of air, (2) pockets of gas, or (3) filler material.

Example 10: The flexible battery of any of Examples 1-9, wherein the gaps and the additional gaps enable the positively charged layer and the negatively charged layer to bend across the coated electrode segment, the additional coated electrode segment, and the another coated electrode segment.

Example 11: The flexible battery of any of Examples 1-10, wherein (1) the positively charged layer comprises a plurality of positively charged layers, (2) the negatively charged layer comprises a plurality of negatively charged layers, (3) the coated electrode segment that includes alternating segments of the positively charged and negatively charged layers, and (4) the additional coated electrode segment that includes additional alternating segments of the positively charged and negatively charged layers.

Example 12: A system comprising (1) a wearable device dimensioned to be donned by a user and (2) a flexible battery coupled to the wearable device, wherein the flexible battery comprising (A) at least one positively charged layer that includes negatively charged material, (B) at least one negatively charged layer that includes positively charged material, (C) a coated electrode segment that includes a segment of the positively charged layer and a segment of the negatively charged layer, and (D) an additional coated electrode segment movably coupled to the coated electrode segment, wherein the additional coated electrode segment includes an additional segment of the positively charged layer and an additional segment of the negatively charged layer.

Example 13: The system of Example 12, wherein the coated electrode segment and the additional coated electrode segment are electrically coupled to one another by (1) a current collector applied across the segment of the positively charged layer and the additional segment of the positively charged layer and (2) an additional current collector applied across the segment of the negatively charged layer and the additional segment of the negatively charged layer.

Example 14: The system of Example 12 or 13, further comprising a dielectric that is positioned between the positively charged layer and the negatively charged layer and electrically insulates the positively charged layer and the negatively charged layer from one another.

Example 15: The system of Example 12-14, further comprising a package that encases the positively charged layer and the negatively charged layer and provides structural support to the coated electrode segment or the additional coated electrode segment.

Example 16: The system of Example 12-15, further comprising an adhesive applied between an interior portion of the package and the positively charged layer or the negatively charged layer.

Example 17: The system of Example 12-16, further comprising a stiffener applied to an exterior portion of the package atop the coated electrode segment or the additional coated electrode segment.

Example 18: The system of Example 12-17, further comprising another coated electrode segment movably coupled to the additional coated electrode segment, wherein the another coated electrode segment includes another segment of the positively charged layer and another segment of the negatively charged layer.

Example 19: The system of Example 12-18, wherein (1) the positively charged layer further comprises a plurality of gaps that separate the segment of the positively charged layer, the additional segment of the positively charged layer, and the another segment of the positively charged layer, and (2) the negatively charged layer further comprises a plurality of additional gaps that separate the segment of the negatively charged layer, the additional segment of the negatively charged layer, and the another segment of the negatively charged layer.

Example 20: A method comprising (1) assembling a coated electrode segment that includes a segment of a positively charged layer and a segment of a negatively charged layer, (2) assembling an additional coated electrode segment that includes an additional segment of the positively charged layer and an additional segment of the negatively charged layer, and (3) movably and electrically coupling the coated electrode segment to the additional coated electrode segment to form a flexible battery.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

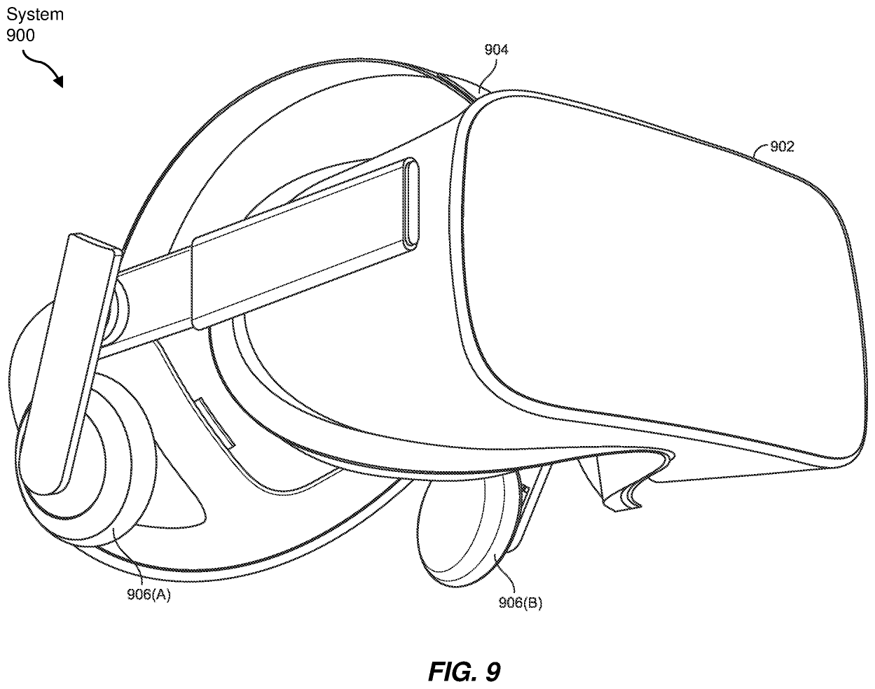

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(1) and 820(J)) that are part of the microphone array (or potentially form their own microphone subarray). Neckband 805 may also include a controller 825 and a power source 835.

Acoustic transducers 820(1) and 820(J) of neckband 805 may be configured to detect sound and convert the detected sound into an electronic format (analog or digital). In the embodiment of FIG. 8, acoustic transducers 820(1) and 820(J) may be positioned on neckband 805, thereby increasing the distance between the neckband acoustic transducers 820(1) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 800 and 900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

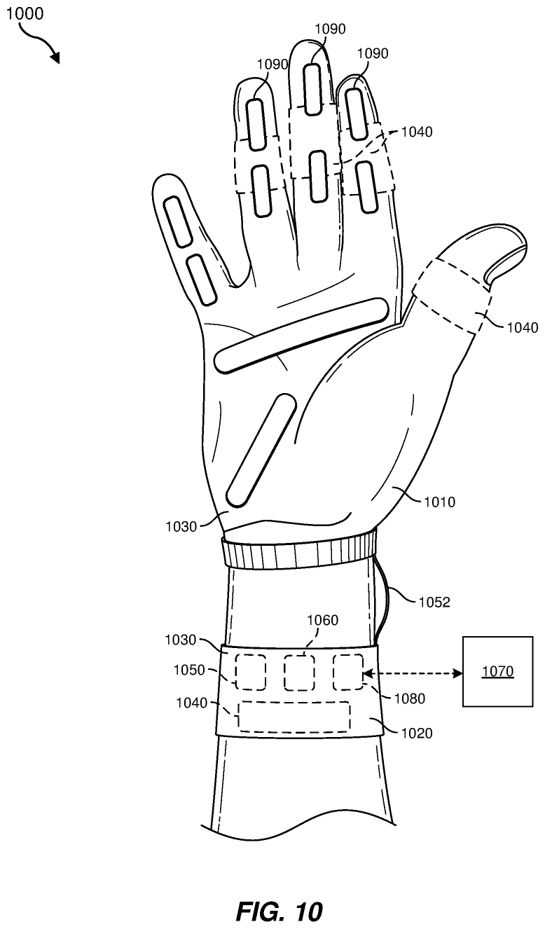

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 10 illustrates a vibrotactile system 1000 in the form of a wearable glove (haptic device 1010) and wristband (haptic device 1020). Haptic device 1010 and haptic device 1020 are shown as examples of wearable devices that include a flexible, wearable textile material 1030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1040 may be positioned at least partially within one or more corresponding pockets formed in textile material 1030 of vibrotactile system 1000. Vibrotactile devices 1040 may be positioned in locations to provide a vibrating sensation (e.g., haptic feedback) to a user of vibrotactile system 1000. For example, vibrotactile devices 1040 may be positioned against the user's finger(s), thumb, or wrist, as shown in FIG. 10. Vibrotactile devices 1040 may, in some examples, be sufficiently flexible to conform to or bend with the user's corresponding body part(s).

A power source 1050 (e.g., a battery) for applying a voltage to the vibrotactile devices 1040 for activation thereof may be electrically coupled to vibrotactile devices 1040, such as via conductive wiring 1052. In some examples, each of vibrotactile devices 1040 may be independently electrically coupled to power source 1050 for individual activation. In some embodiments, a processor 1060 may be operatively coupled to power source 1050 and configured (e.g., programmed) to control activation of vibrotactile devices 1040.

Vibrotactile system 1000 may be implemented in a variety of ways. In some examples, vibrotactile system 1000 may be a standalone system with integral subsystems and components for operation independent of other devices and systems. As another example, vibrotactile system 1000 may be configured for interaction with another device or system 1070. For example, vibrotactile system 1000 may, in some examples, include a communications interface 1080 for receiving and/or sending signals to the other device or system 1070. The other device or system 1070 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1080 may enable communications between vibrotactile system 1000 and the other device or system 1070 via a wireless (e.g., Wi-Fi, BLUETOOTH, cellular, radio, etc.) link or a wired link. If present, communications interface 1080 may be in communication with processor 1060, such as to provide a signal to processor 1060 to activate or deactivate one or more of the vibrotactile devices 1040.

Vibrotactile system 1000 may optionally include other subsystems and components, such as touch-sensitive pads 1090, pressure sensors, motion sensors, position sensors, lighting elements, and/or user interface elements (e.g., an on/off button, a vibration control element, etc.). During use, vibrotactile devices 1040 may be configured to be activated for a variety of different reasons, such as in response to the user's interaction with user interface elements, a signal from the motion or position sensors, a signal from the touch-sensitive pads 1090, a signal from the pressure sensors, a signal from the other device or system 1070, etc.

Although power source 1050, processor 1060, and communications interface 1080 are illustrated in FIG. 10 as being positioned in haptic device 1020, the present disclosure is not so limited. For example, one or more of power source 1050, processor 1060, or communications interface 1080 may be positioned within haptic device 1010 or within another wearable textile.

Haptic wearables, such as those shown in and described in connection with FIG. 10, may be implemented in a variety of types of artificial-reality systems and environments.

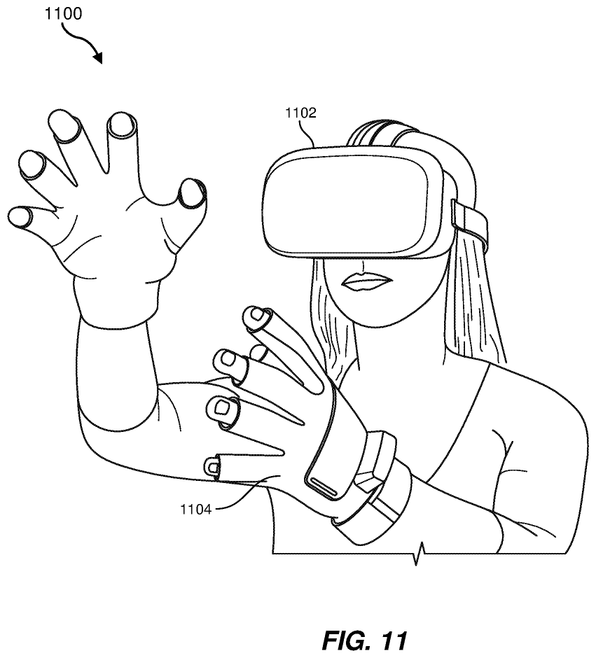

FIG. 11 shows an example artificial-reality environment 1100 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1102 generally represents any type or form of virtual-reality system, such as virtual-reality system 900 in FIG. 9. Haptic device 1104 generally represents any type or form of wearable device, worn by a user of an artificial-reality system, that provides haptic feedback to the user to give the user the perception that he or she is physically engaging with a virtual object. In some embodiments, haptic device 1104 may provide haptic feedback by applying vibration, motion, and/or force to the user. For example, haptic device 1104 may limit or augment a user's movement. To give a specific example, haptic device 1104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1104 to send action requests to a console. Examples of action requests include, without limitation, requests to start an application and/or end the application and/or requests to perform a particular action within the application.

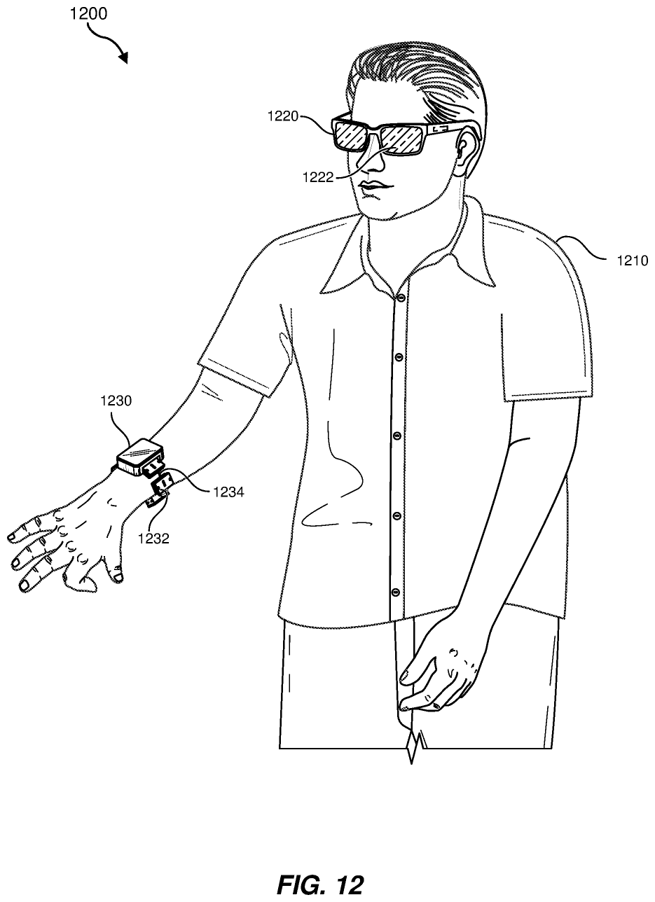

While haptic interfaces may be used with virtual-reality systems, as shown in FIG. 11, haptic interfaces may also be used with augmented-reality systems, as shown in FIG. 12. FIG. 12 is a perspective view of a user 1210 interacting with an augmented-reality system 1200. In this example, user 1210 may wear a pair of augmented-reality glasses 1220 that may have one or more displays 1222 and that are paired with a haptic device 1230. In this example, haptic device 1230 may be a wristband that includes a plurality of band elements 1232 and a tensioning mechanism 1234 that connects band elements 1232 to one another.

One or more of band elements 1232 may include any type or form of actuator suitable for providing haptic feedback. For example, one or more of band elements 1232 may be configured to provide one or more of various types of cutaneous feedback, including vibration, force, traction, texture, and/or temperature. To provide such feedback, band elements 1232 may include one or more of various types of actuators. In one example, each of band elements 1232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1010, 1020, 1104, and 1230 may include any suitable number and/or type of haptic transducer, sensor, and/or feedback mechanism. For example, haptic devices 1010, 1020, 1104, and 1230 may include one or more mechanical transducers, piezoelectric transducers, and/or fluidic transducers. Haptic devices 1010, 1020, 1104, and 1230 may also include various combinations of different types and forms of transducers that work together or independently to enhance a user's artificial-reality experience. In one example, each of band elements 1232 of haptic device 1230 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A flexible battery comprising:
at least one positively charged layer;
at least one negatively charged layer;
a coated electrode segment that includes a segment of the positively charged layer and a segment of the negatively charged layer; and
an additional coated electrode segment movably coupled to the coated electrode segment, wherein the additional coated electrode segment includes an additional segment of the positively charged layer and an additional segment of the negatively charged layer.

2. The flexible battery of claim 1, wherein the coated electrode segment and the additional coated electrode segment are electrically coupled to one another by:
a current collector applied across the segment of the positively charged layer and the additional segment of the positively charged layer; and
an additional current collector applied across the segment of the negatively charged layer and the additional segment of the negatively charged layer.

3. The flexible battery of claim 1, further comprising a separator that is positioned between the positively charged layer and the negatively charged layer and electrically insulates the positively charged layer and the negatively charged layer from one another.

4. The flexible battery of claim 1, further comprising a package that encases the positively charged layer and the negatively charged layer and provides structural support to the coated electrode segment or the additional coated electrode segment.

5. The flexible battery of claim 4, further comprising an adhesive applied between an interior portion of the package and the positively charged layer or the negatively charged layer.

6. The flexible battery of claim 4, further comprising a stiffener applied to an exterior portion of the package surrounding the coated electrode segment or the additional coated electrode segment.

7. The flexible battery of claim 1, further comprising another coated electrode segment movably coupled to the additional coated electrode segment, wherein the another coated electrode segment includes another segment of the positively charged layer and another segment of the negatively charged layer.

8. The flexible battery of claim 7, wherein:
the positively charged layer further comprises a plurality of gaps that separate the segment of the positively charged layer, the additional segment of the positively charged layer, and the another segment of the positively charged layer; and
the negatively charged layer further comprises a plurality of additional gaps that separate the segment of the negatively charged layer, the additional segment of the negatively charged layer, and the another segment of the negatively charged layer.

9. The flexible battery of claim 8, wherein the gaps and the additional gaps comprise at least one of:
pockets of air;
pockets of gas; or
filler material.

10. The flexible battery of claim 8, wherein the gaps and the additional gaps enable the positively charged layer and the negatively charged layer to bend across the coated electrode segment, the additional coated electrode segment, and the another coated electrode segment.

11. The flexible battery of claim 1, wherein:
the positively charged layer comprises a plurality of positively charged layers;
the negatively charged layer comprises a plurality of negatively charged layers;
the coated electrode segment that includes alternating segments of the positively charged and negatively charged layers; and
the additional coated electrode segment that includes additional alternating segments of the positively charged and negatively charged layers.

12. A system comprising:
a wearable device dimensioned to be donned by a user; and
a flexible battery coupled to the wearable device, wherein the flexible battery comprising:
at least one positively charged layer;
at least one negatively charged layer;
a coated electrode segment that includes a segment of the positively charged layer and a segment of the negatively charged layer; and
an additional coated electrode segment movably coupled to the coated electrode segment, wherein the additional coated electrode segment includes an additional segment of the positively charged layer and an additional segment of the negatively charged layer.

13. The system of claim 12, wherein the coated electrode segment and the additional coated electrode segment are electrically coupled to one another by:
a current collector applied across the segment of the positively charged layer and the additional segment of the positively charged layer; and
an additional current collector applied across the segment of the negatively charged layer and the additional segment of the negatively charged layer.

14. The system of claim 12, further comprising a separator that is positioned between the positively charged layer and the negatively charged layer and electrically insulates the positively charged layer and the negatively charged layer from one another.

15. The system of claim 12, further comprising a package that encases the positively charged layer and the negatively charged layer and provides structural support to the coated electrode segment or the additional coated electrode segment.

16. The system of claim 15, further comprising an adhesive applied between an interior portion of the package and the positively charged layer or the negatively charged layer.

17. The system of claim 15, further comprising a stiffener applied to an exterior portion of the package surrounding the coated electrode segment or the additional coated electrode segment.

18. The system of claim 12, further comprising another coated electrode segment movably coupled to the additional coated electrode segment, wherein the another coated electrode segment includes another segment of the positively charged layer and another segment of the negatively charged layer.

19. The system of claim 18, wherein:
the positively charged layer further comprises a plurality of gaps that separate the segment of the positively charged layer, the additional segment of the positively charged layer, and the another segment of the positively charged layer; and
the negatively charged layer further comprises a plurality of additional gaps that separate the segment of the negatively charged layer, the additional segment of the negatively charged layer, and the another segment of the negatively charged layer.

20. A method comprising:
assembling a coated electrode segment that includes a segment of a positively charged layer and a segment of a negatively charged layer;
assembling an additional coated electrode segment that includes an additional segment of the positively charged layer and an additional segment of the negatively charged layer; and
movably and electrically coupling the coated electrode segment to the additional coated electrode segment to form a flexible battery.
